(19) United States
(12) Patent Application Publication
(10) Pub. No.: US 2009/0160611 A1
(43) Pub. Date: Jun. 25, 2009

(54) Enhanced Communication Via RFID Interrogator

(75) Inventors: Russell Calvarese, Stony Brook, NY (US); Mark Duron, East Patchogue, NY (US); Thomas Wulff, North Patchogue, NY (US); Robert Sandler, Melville, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/960,347

(22) Filed: Dec. 19, 2007

(51) Int. Cl. H04B 7/00

(52) U.S. Cl. 340/10.1

(57) ABSTRACT

An RFID portal is enhanced to provide communication capability to RFID communication enabled devices. Such devices include cameras, PDAs, voice communicator, keyboards, displays, indicators, storage devices, etc. Devices are made RFID communication enabled by providing them with an RFID interface and an RFID tag “front end”. Such an enhanced device communicates with an enhanced portal via an RFID reader/interrogator associated with the portal. The portal may have connection to other communication channels, such as an Ethernet tie to a network, a landline phone connection, a cellular interface, an 802.11 connection, a Bluetooth channel, etc. Such connections allow an RFID communication enabled device to communicate beyond the enhanced portal to the outside world.

### BACKGROUND

The invention relates in general to the arrangement and use of radio frequency identification (RFID) tags and systems. In particular, the invention relates to the use of an RFID portal as a communication access point for receiving data from and sending data to devices equipped with an RFID tag “front end”. Such devices are referred to herein as “RFID Comm Enhanced” devices.

Radio frequency identification (RFID) tags are electronic devices that are typically attached to items whose presence is to be detected and/or monitored. For example, they are quite useful in inventory control and tracking. RFID tags are classified based on standards defined by national and international standards bodies (e.g., EPC Global and ISO). Standard tag classes include Class 0, Class 1, and Class 1 Generation 2 (referred to herein as “Gen 2”). The presence of an RFID tag, and therefore the presence of the item to which the tag is affixed, may be checked and monitored wirelessly by an “RFID reader”, also known as a “reader-interrogator”, “interrogator”, or simply “reader.” Readers typically have one or more antennas for transmitting radio frequency signals to RFID tags and receiving responses from them. An RFID tag within range of a reader-transmitted signal responds with a signal including a unique identifier associated with only that particular RFID tag. Thus, an item to which an RFID tag is attached is uniquely identified by its tag responding to an RFID interrogator signal.

With the maturation of RFID technology, efficient communication between tags and readers has become a key enabler in supply chain management, especially in manufacturing, shipping, and retail industries, as well as in building security installations, healthcare facilities, libraries, airports, warehouses etc. Many processes, as well as the status of many items, may be readily monitored via RFID tags.

However, traditionally, an RFID tags only communicates information indicative of its unique identifier. It is not useful for communicating any other information even though a communication channel is established between an RFID tag and an interrogator. An RFID portal, typically including an RFID interrogator, traditionally function only to send interrogation signals looking for the presence of RFID tags, read response signals (backscatter) from RFID tags bearing RFID tag identifying information, and keep track of the various RFID tag “reads” that occur so that received information can be used by software to provide some inventory control function. Such portals are not capable of further communication functions.

### SUMMARY

This section is for the purpose of summarizing some aspects of the inventions described more fully in other sections of this patent document. It briefly introduces some preferred embodiments. Simplifications or omissions may be made to avoid obscuring the purpose of the section. Such simplifications or omissions are not intended to limit the scope of the claimed inventions.

The inventions relate generally to providing additional functionality and capability to an otherwise conventional RFID portal. In a conventional RFID system, a portal includes an RFID reader/interrogator. It regularly transmits an interrogation signal to any RFID tags that may be within range of the portal. An RFID tag within range responds with a backscatter signal including identification data indicating the identity of the tag responding.

The invention described herein provides enhanced communication functionality for RFID portals and for various devices. An ordinary device, such as, for example, a PDA, phone, digital camera, keyboard, touchpad, etc. can be enhanced to create an RFID enhanced device by providing it with an RFID interface and an RFID transponder acting as a “front end” for communication with an enhanced RFID portal. A typical RFID portal is enhanced by providing it with augmented software/firmware and additional communication capabilities.

An RFID enhanced device, in addition to transmitting its usual unique ID information to a portal, is able to transfer of other types of digital data. For example, an RFID enhanced digital camera can transmit its digital image files to an enhanced portal using an RFID communication channel established between its RFID transponder and an interrogator associated with the enhanced portal.

In an embodiment, an enhanced portal has portal firmware installed therein that processes data (from an RFID enhanced device) in addition to the normal identification data that would be received from an RFID tag.

An ordinary device can be transformed into an RFID enhanced device by fitting it with an active or passive RFID transponder and an appropriate interface. Systems using active or passive RFID transponders as their front end, transfer data to an enhanced portal. An enhanced portal, like an ordinary portal, is typically connected to some backend infrastructure via a Ethernet or 802.11 connection. Enhanced portals may have added peripheral devices associated with them. For example, an enhanced portal may have an associated display, keyboard, mass storage device, speaker, etc. It may also be fitted with additional communication capability such as, for example, a Bluetooth transceiver, an infrared transceiver, etc. RFID enhanced devices are able to gain access to any enhanced portal resource simply by being within range of the enhanced portal. Enhanced portal resources may include, but are not limited to: Ethernet connection, 802.11 communication facility, memory, data input devices, speakers, microphones, keyboard, camera, indicators and displays. Similarly, resources of an RFID enhanced device can be accessed by the enhanced portal.

Devices intended to communicate with the portal can be hung on hooks near the portal antenna to charge (using the charge pump of the RFID transponder or other energy harvesting techniques) their internal batteries from the relatively large field strength near the antenna of the enhanced portal.

In an embodiment one RFID enhanced device is a portable communicator. Like a conventional cell or mobile phone, it has a microphone and speaker. However, a modulator produces a stream of digital data corresponding to a voice signal. That digital data is communicated via its RFID transponder thereby allowing a voice over IP (VOIP) telephone call to be made. A user can make a VOIP call using the nearest RFID portal to access various networks via the portals communication connections (802.11, Ethernet, etc.).

A portable keypad can be used to program and control an enhanced portal.

A portable camera can automatically “dump” its digital image objects as it passes through an enhanced portal.

A portable device can collect a history log from a portal that does not have a communication connection to some infrastructure so that the history log can be carried to remote location.

A portal alternative can be provided by associating an RFID interrogator with an access point such that RFID enhanced devices can gain network access without a full portal.

The invention can be implemented in numerous ways, including methods, systems, devices, and computer readable medium. Several embodiments of the invention are described below, but they are not the only ways to practice the invention described herein.

### BRIEF DESCRIPTION OF THE DRAWINGS/FIGURES

The accompanying drawings, which are incorporated herein and form a part of the specification, illustrate the invention and, together with the description, further serve to explain the principles of the invention and to enable a person skilled in the pertinent art to make and use the invention.

In the drawings, like reference numbers indicate identical or functionally similar elements.

Additionally, references numbers which are the same, but vary by virtue of an appended letter of the alphabet (for example, 412, 412R, 412P, 412S) or an appended letter and number (for example, 412, 412S1, 412S2) indicate elements which may be substantially the same or similar, but represent variations or modifications of the basic element. In some cases, the reference number without the appended letter or without the appended letter and number (for example, 412) may indicate a generic form of the element, while reference numbers with an appended letter or an appended letter and number (for example, 412S, 412S1, 412S2, 412P) may indicate a more particular or modified form of the element.

Additionally, the leftmost digit(s) of a reference number identifies the drawing in which the reference number first appears. For example, an element labeled 412 typically indicates that the element first appeared in FIG. 4.

FIG. 1 shows an environment where RFID readers (interrogators) communicate with an exemplary population of RFID tags.

FIG. 2 is a block diagram of receiver and transmitter portions of an RFID reader.

FIG. 3 is a block diagram of an exemplary radio frequency identification (RFID) tag.

FIG. 4A is a schematic diagram of a typical RFID portal.

FIG. 4B is a schematic diagram of an enhanced RFID portal according to the invention.

FIG. 5 is a schematic diagram showing an enhanced portal 400 with various peripheral devices attached thereto and communication link to infrastructure 430.

FIG. 6 is a schematic diagram illustrating a general principle of the invention.

FIG. 7 is a schematic diagram of an embodiment of the invention featuring an enhanced camera 534, that has been fitted with an RFID transponder 524.

FIG. 8 is a schematic diagram of an embodiment of the invention featuring a portable keypad 802 as an enhance device.

FIG. 9 is a schematic diagram of a system including an enhanced portal 400 and an enhanced storage device 902.

FIG. 10 is a schematic diagram of an embodiment of the invention. It includes enhanced device 1002 which may include, but is not limited to an enhanced PDA 1004, an enhanced keyboard 1006 and an enhanced camera 1008.

FIG. 11 is a schematic diagram of an RFID transponder 524.

FIG. 12 is a schematic diagram of an interface suitable for adapting an ordinary device to communicate with RFID transponder 524 shown in FIG. 11.

FIG. 13 is a flow chart of software or firmware for operating the enhanced portal.

### DETAILED DESCRIPTION

In the following description, numerous specific details are set forth in order to provide a thorough understanding of the invention. However, it will be apparent to those skilled in the art that the invention, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

RFID Tag Basics

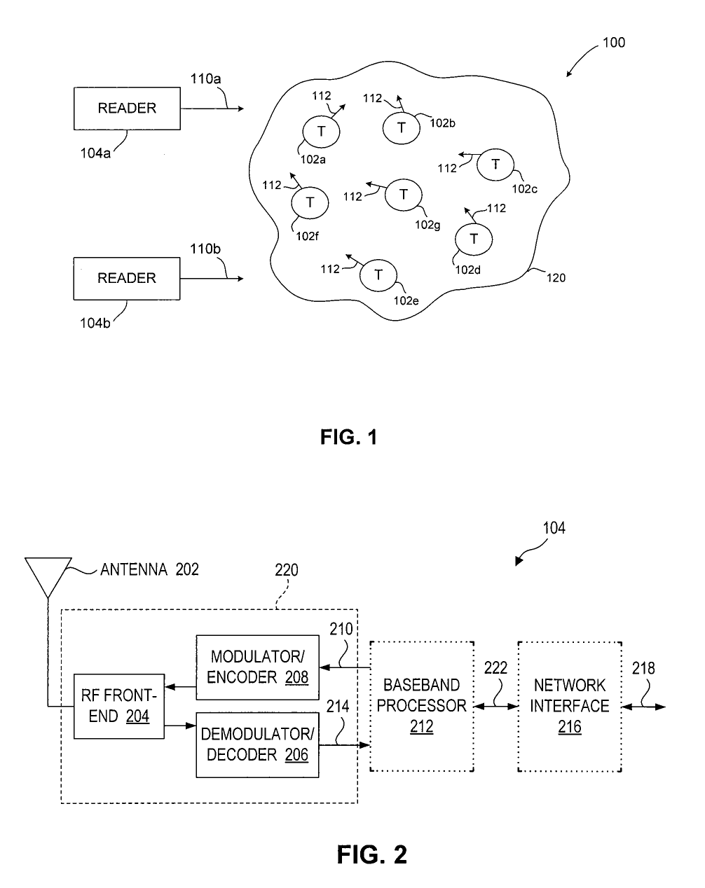

Before describing embodiments of the invention in detail, it is helpful to describe the arrangement and implementation of an RFID tag system. FIG. 1 illustrates an environment 100 where RFID tag readers 104 (readers 104a and 104b shown in FIG. 1) communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network (see FIG. 2).

As shown in FIG. 1, reader 104a “reads” tags 120 by transmitting an interrogation signal 110a to the population of tags 120. Interrogation signals may have signal carrier frequencies or may comprise a plurality of signals transmitted in a frequency hopping arrangement. Readers 104a and 104b typically operate in one or more of the frequency bands allotted for this type of RF communication. For example, the Federal Communication Commission (FCC) defined frequency bands of 902-928 MHz and 2400-2483.5 MHz for certain RFID applications.

Tag population 120 may include tags 102 of various types, such as, for example, various classes of tags as enumerated above. Thus, in response to interrogation signals, the various tags 102 may transmit one or more response signals 112 to an interrogating reader 104. Some of the tags, for example, may respond by alternatively reflecting and absorbing portions of signal 104 according to a time-based pattern or frequency. This technique for alternatively absorbing and reflecting signal 104 is referred to herein as backscatter modulation. Typically, such backscatter modulation may include one or more alpha-numeric characters that uniquely identify a particular tag. Readers 104a and 104b receive and obtain data from response signals 112, such as an identification number of the responding tag 102. In the embodiments described herein, a reader may be capable of communicating with tags 102 according to various suitable communication protocols, including Class 0, Class 1, EPC Gen 2, other binary traversal protocols and slotted aloha protocols, and any other protocols mentioned elsewhere herein, and future communication protocols. Additionally, tag population 120 may include one or more tags having the packed object format described herein and/or one or more tags not using the packed object format (e.g., standard ISO tags).

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including for example and without limitation, a vertical, dipole, loop, Yagi-Uda, slot, and patch antenna type.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as, for example, one of pulse-interval encoding (PIE), FM0, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to one within a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

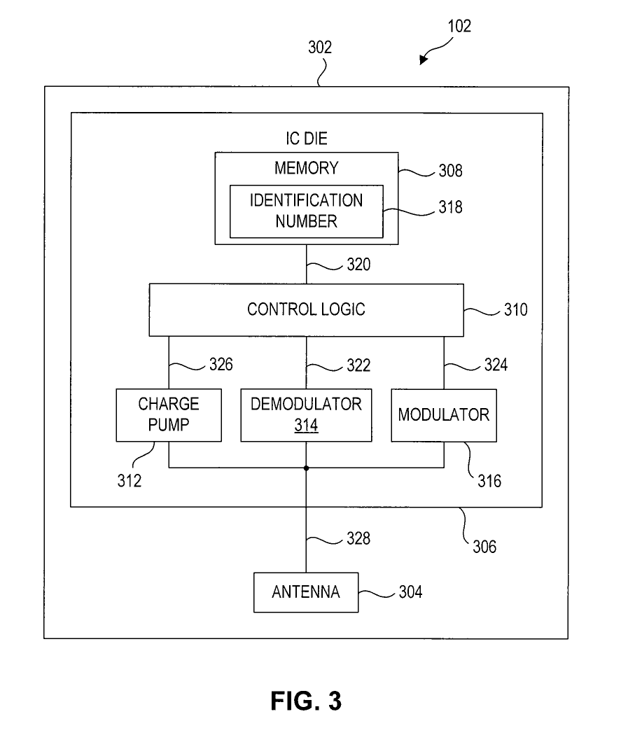

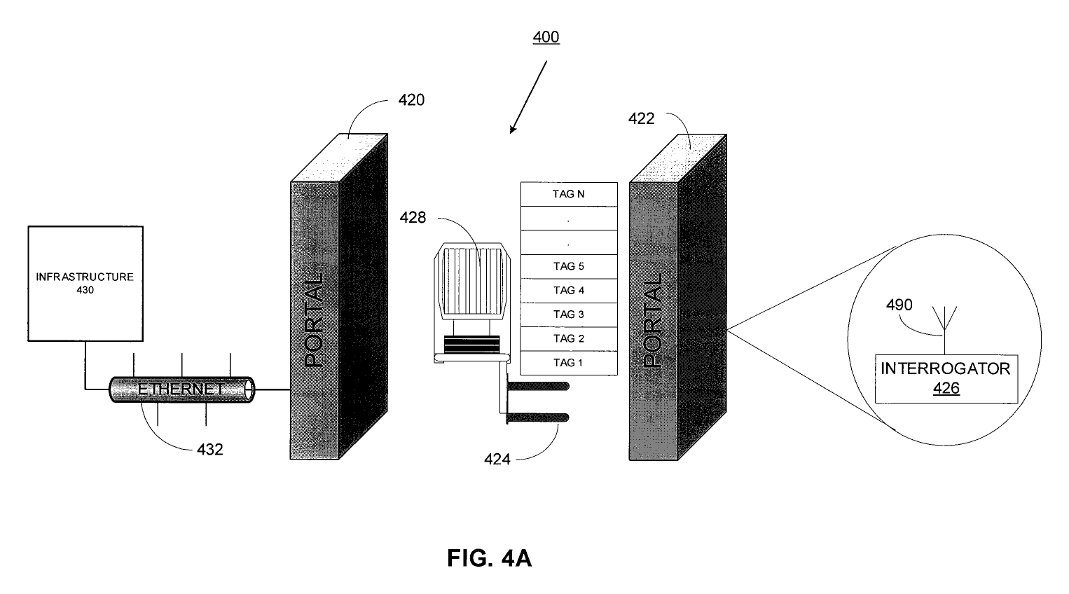

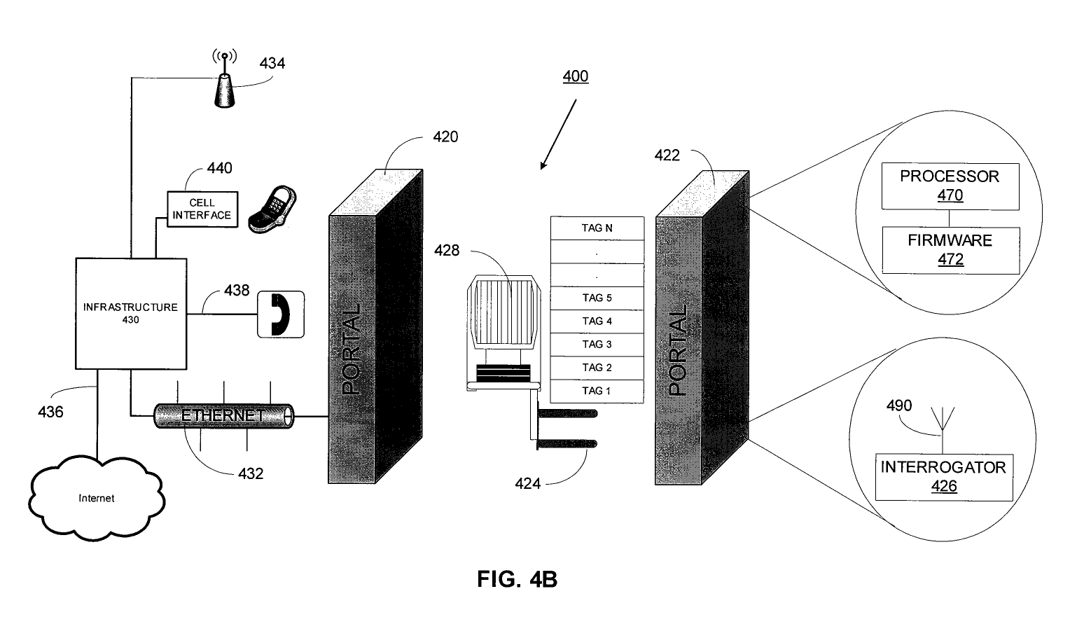

The invention described herein is applicable to any type of RFID tag, with suitable additional features, as described in further detail below in conjunction with FIG. 4 and beyond. FIG. 3 is a schematic block diagram of an example radio frequency identification (RFID) tag 102 as already known to those practiced in the art. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including for example dipole, loop, slot, and patch. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. Inputs of charge pump 312, and demodulator 314, and an output of modulator 316 are coupled to antenna 304 by antenna signal 328.

Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on an input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112 (see FIG. 1), which is received by reader 104. In one example embodiment, modulator 316 includes a switch, such as a single pole, single throw (SPST) switch. The switch is configured in such a manner as to change the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 powers circuits of IC die 306, including control logic 320.

Charge pump 312 rectifies a portion of the power of the radio frequency communication signal of antenna signal 328 to create a voltage power. Charge pump 312 increases the voltage level of the rectified power to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3 as a passive tag, tag 102 may alternatively be an active tag (e.g., powered by a battery, not shown).

Memory 308 is typically a non-volatile memory, but can alternatively be a volatile memory, such as a DRAM. Memory 308 stores data, including an identification number 318. In a Gen-2 tag, tag memory 308 may be logically separated into four memory banks.

Typical Portal Configuration and Use

FIG. 4A is a schematic diagram of an RFID portal 400. Typically, a portal has at least one RFID “reader/interrogator”, such as interrogator 426 and one or more antennas such as antenna 490 housed within a housing, such as housing 420. A typical portal installation may include two housings (although many installations have only a single portal structure and some have more than two portal structures), such as housing 420 and housing 422, positioned in a manner to mark the boundaries of a pathway through which items affixed with RFID tags travel. For example, a pallet 424 of RFID tagged items, carried by a fork lift 428, may be transported through a portal in a warehouse so that an interrogator 426 associated with the portal can register that particular tags, such as “TAG 1” . . . “TAG N”, have come into “view” and thereby keep track of all tagged goods passing from one point in the warehouse to another. Portal 400 may be connected to infrastructure 430 via an Ethernet connection 432.

Enhanced Communication for Portal

The portal shown in FIG. 4B is “enhanced” in that it has communication capabilities that can be utilized in various ways as will be further explained below. Infrastructure 430 may connect to the “outside world” through an 802.11 connection 434 or by, for example a direct connection 436 to the internet 486. It may also be connected to a conventional telephone land line 438 or have a cellular interface 440. Such connections to the outside world make possible various enhanced communication capabilities of portal 400. Portal 400 has a processor 470, operated by firmware 472 that is designed to in a manner to handle the communication of various data communicated between an enhanced portal and an RFID enhanced device.

RFID Communication Enabled Device

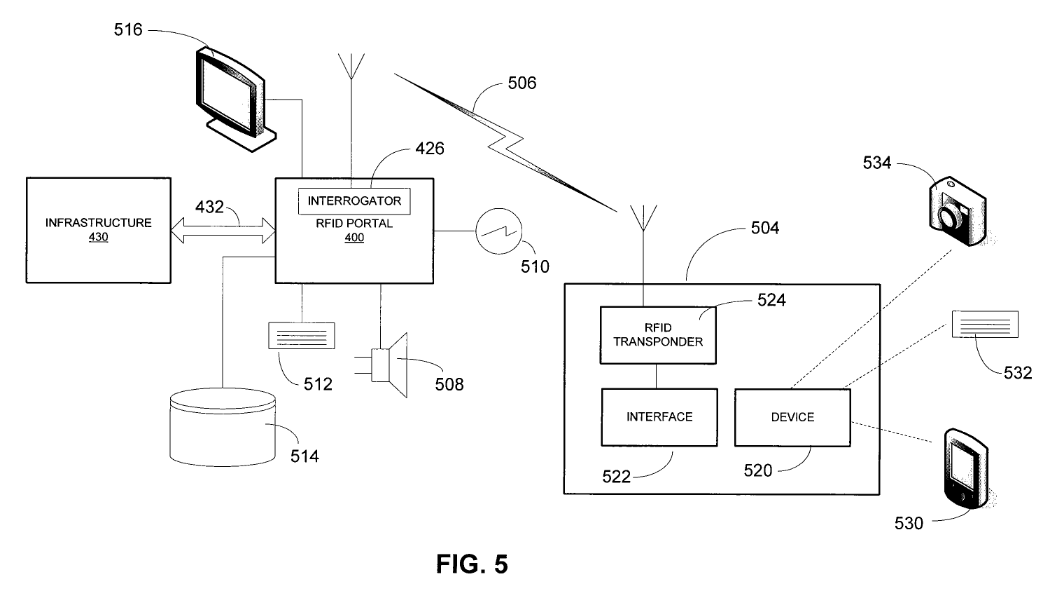

FIG. 5 is a schematic diagram explaining a basic concept of the invention. An enhanced portal 500 communicates with infrastructure 430 via an Ethernet connection 432. Portal 400 has various peripheral devices attached to it with are operated by a processor (not shown) under the control of firmware (not shown). An interrogator 426 performs dual roles: 1) receiving RFID tag responses to interrogation signals, and 2) communicating with RFID enhanced devices 504, via an RFID communication channel 506.

Enhanced portal 500 has various resources in the form of peripheral devices including a speaker transducer 508, a Bluetooth communication device 510, a keyboard 512, a mass storage device 514 and a display 516. As will be further described, enhanced device 504 can access and make use of the various resources of portal 500 including its peripheral devices and its various communication capabilities, all through communication channel 506. Enhanced device 504 is created by fitting an ordinary device 520 with an RFID transponder 524 and an appropriate interface 522. Device 520 can be any of a variety of devices that might benefit from communication with portal 500 or which might enhance portal 500 by making its own resources available to it.

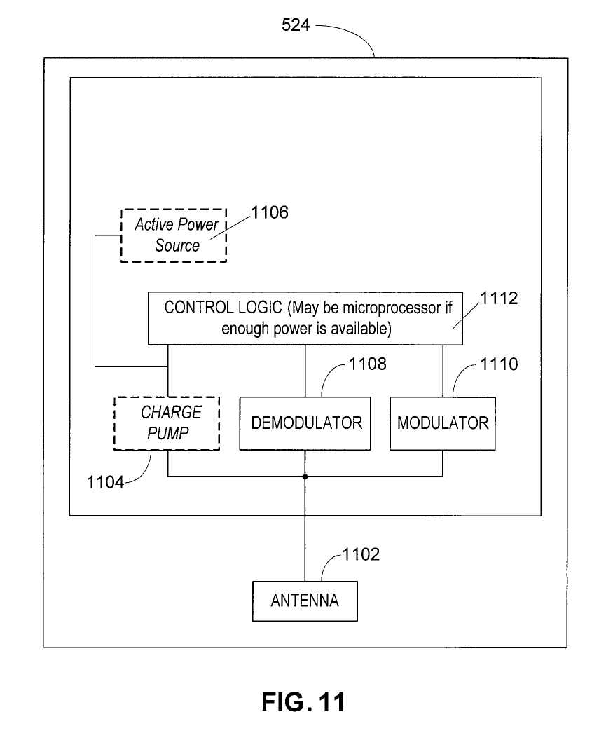

Interface 522 and RFID transponder 524 can be considered to be “add on” modules that can be fitted to ordinary devices 520 such as, for example, a PDA 530, a keyboard 532 or a camera 534. Ordinary device 520 can be other devices as well. A schematic diagram of interface 522 is shown in FIG. 10. A schematic diagram of RFID transponder 524 is shown in FIG. 11.

Enhanced communication capabilities can be provided for an RFID tag in at least two ways. A first way to provide enhanced communication functions is to map existing tag memory space to new communication functions. Using this approach there is little software overhead associated with managing these communication functions. Existing protocols used for RFID tags can be extended, but few extension are necessary. A second way to provide enhanced communication functions is to implement a new protocol that is specifically designed for enhanced devices. Using this approach, tag memory is not critical to the implementation.

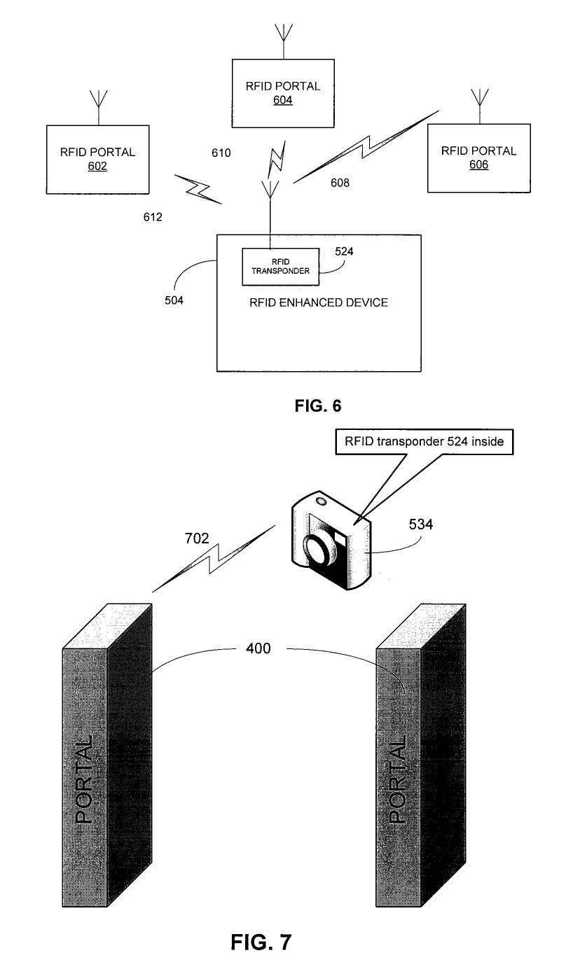

FIG. 6 is a schematic diagram illustrating a general principle of the invention. An RFID enhanced device 504 includes an RFID transponder 524 that is able to communicate with any of a plurality of enhanced portals such as 602, 604, and 606. Such communication occurs over various RFID communication channels 608, 610 and 612, respectively associated with portals 606, 604, and 602.

FIG. 7 is a schematic diagram of an embodiment of the invention featuring an enhanced camera 534, that has been fitted with an RFID transponder 524. In the presence of an enhanced portal 400, camera 534 is able to “dump” its images via a communication channel 702 to enhanced portal 400 utilizing the reader/interrogator 426 (not shown in FIG. 7) incorporated into the enhanced portal.

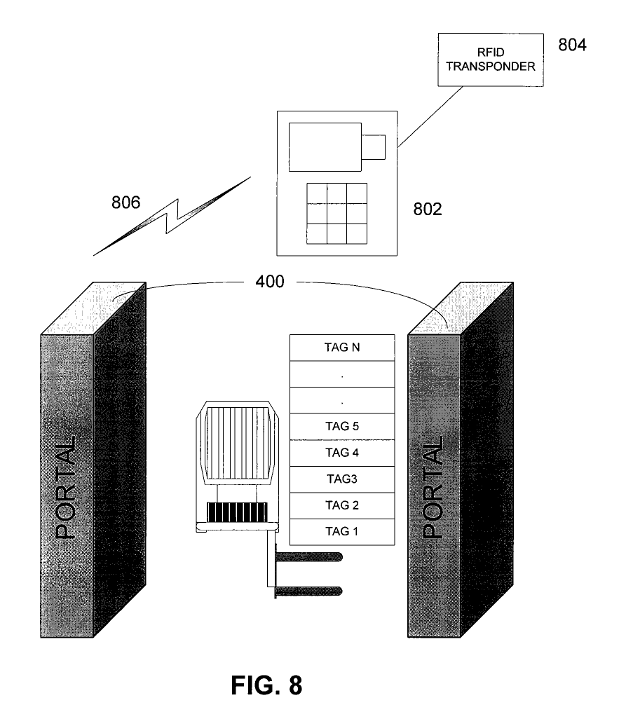

FIG. 8 is a schematic diagram of an embodiment of the invention featuring a portable keypad 802 as an enhance device. Keypad 802 has been fitted with an RFID transponder 524. The portable keypad is then able to access enhanced portal 400 via an RFID communication channel 806 using portable keypad 802 in the presence of portal 400, an operator can change programming of portal 400 and perform other tasks with respect to portal 400, including manipulating data related to various tags such as tag 1 . . . N read by portal 400.

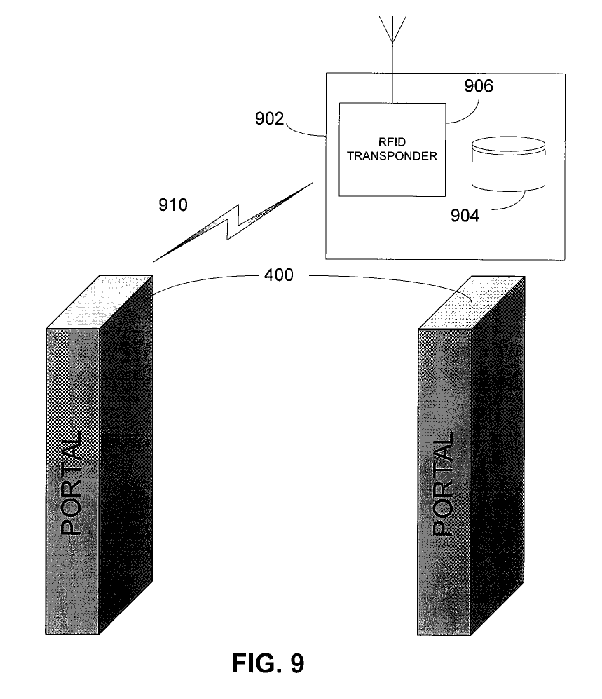

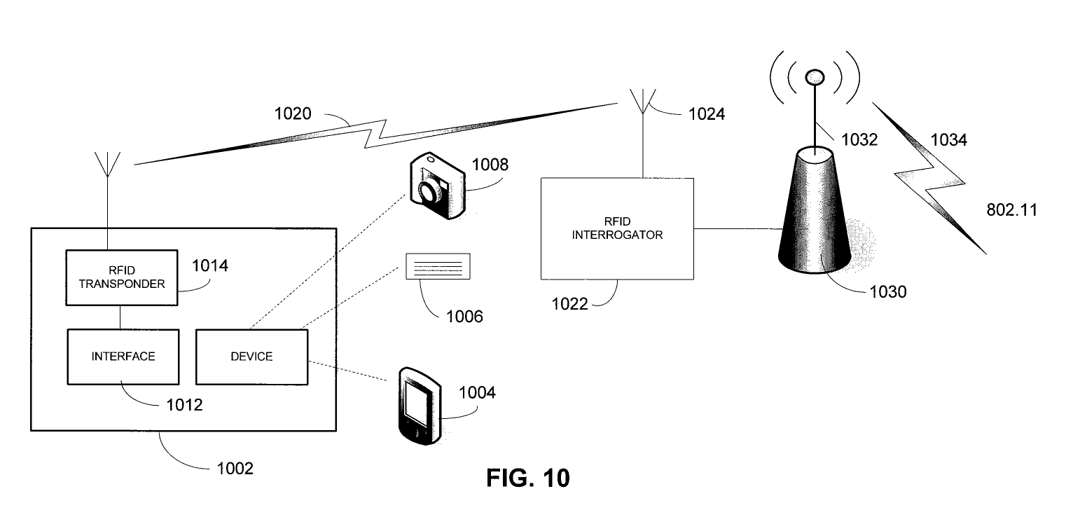

FIG. 9 is a schematic diagram of a system including an enhanced portal 400 and an enhanced storage device 902. A conventional storage device 904, such as a hard drive with associated driving circuitry is fitted with an RFID transponder 906. Using a communication channel 910, established between portal 400 and RFID transponder 906, portal 400 is able to access data and write data to storage device 904 using communication channel 910.

FIG. 10 is a schematic diagram of an embodiment of the invention. It includes enhanced device 1002 which may include, but is not limited to an enhanced PDA 1004, an enhanced keyboard 1006 and an enhanced camera 1008. In general, the device that is enhanced is referred to by reference numeral 1010. Device 1010 is associated with an interface 1012 and an RFID transponder 1014. RFID transponder 1014 may communicate via an RFID communication channel 1020 to an RFID interrogator 1022, having an antenna 1024. RFID interrogator may be part of an enhanced portal such as portal 400 shown in FIG. 9 and in other figures. RFID interrogator 1022 is associated with a further communication channel such as, for example, an 802.11 connection 1030, symbolized by antenna 1032 and arrow 1034. Using this scheme, any enhanced device, such as PDA 1004, keyboard 1006 and camera 1008 can communicate to the internet via RFID communication channel 1020, RFID interrogator 1022 and 802.11 connection 1034.

Thus, using the principles of the invention, it is possible for enhanced devices to communicate with an enhanced portal. It is also possible for devices to make use of peripheral devices attached to the enhanced portal and for the enhanced portal to make use of or access peripheral devices that are enhanced by the addition of an interface and RFID interrogator.

RFID Transponder

FIG. 11 is a schematic diagram of an RFID transponder 524. Transponder 524 receives signals from and transmits signals to an interrogator (not shown) via an antenna 1102. Some energy from received signals may be harvested by an optional charge pump 1104 which can provide power to the various circuits of transponder 524. A transponder 524 may have an optional active power source 1106. In some arrangements, a transponder 524 may have both a charge pump 1104 and an active power source 1106 such as a rechargeable battery. Information contained in signals received from the interrogator at antenna 1102 are demodulated by a demodulator 1108. Information to be sent to the interrogator via a backscatter or other transmission is modulated onto the transmitted signal using a modulator 1110. Control logic 1112, which may reside in firmware, controls the functions of modulator 1110 and demodulator 1108.

Interface

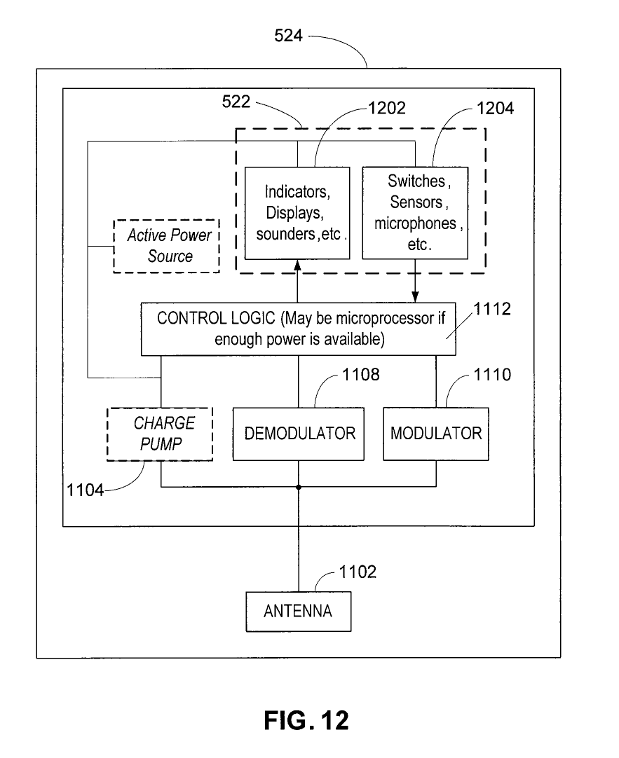

FIG. 12 is a schematic diagram of a transponder 524 including components of interface 522 suitable for adapting an ordinary device to communicate with the transponder. Components common to FIGS. 11 and 12 will not be described. Control logic 1112, in addition to controlling modulator 1110 and demodulator 1108, also control indicators, displays, sounders, etc. 1202 and switches, sensors, microphones, etc. 1204 as needed to interact with a device 520 (see FIG. 5) so that it can communicate via transponder 524 and be controlled as necessary by signals received via transponder 524. For example, in the case of a camera 534, as shown in FIG. 5), control logic 1112 upon receipt of a “download” signal from demodulator 1108, would communicate the appropriate command to camera 534 to read its electronic image files from its memory and send them via switches, sensors, microphones, etc. 1204 to control logic 1112 so that information corresponding to the image files can be modulated by modulator 1110 onto a backscatter signal responding to an interrogator.

Enhanced Portal Software/Firmware

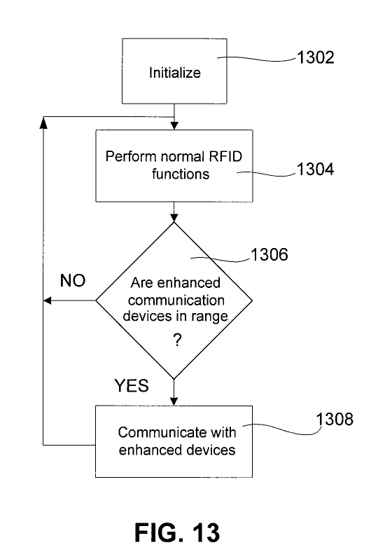

FIG. 13 is a flow chart explaining the operation of an enhanced portal. The interrogator (such as interrogator 426 shown in FIG. 4A) includes a microprocessor and/or control logic that may be in the form of software or firmware for controlling the operations of an enhanced portal. At 1302 operations of the interrogator are initialized. Most of the time the interrogator will performing its normal functions, i.e. regularly sending interrogation signals and listening for responses from any RFID tags that may be nearby. A backscatter signal from a nearby RFID tag will typically including information identifying the particular tag responding by including the tag's unique identifying number coded into the backscatter transmission. Such normal interrogating operations are carried out at 1304. Periodically, control passes to 1306 during which the interrogator tries to identify any enhanced communication devices within its range. When the interrogator identifies an enhanced device within its range at 1306, control passes to 1308. At 1308 communication is established according to predetermined protocols between the interrogator and the enhanced device. After communication has occurred between the enhanced device and the interrogator, control passes back to 1304 and the interrogator resumes its normal task of sending periodic interrogation signals to any RFID tags that may be within its range. Security support is provided to protect communication including voice and data via an interrogator associated with an access portal. Such support can be provided in the same manner as it is for other forms of communication, e.g. encrypting, rights management, etc.

Conclusion

The above examples of a system and method for customizable, mechanically programmable RFID tags are exemplary only. Persons skilled in the relevant arts will recognize that a variety of alternatives may exist in terms of materials, relations of structural and operational elements, and methods of employing or applying the same. Such variations fall within the scope and spirit of the invention which is not limited by the particular examples described above.

While various embodiments of the invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the invention should not be limited by any of the above-described exemplary embodiments, but should be defined only in accordance with the following claims and their equivalents.

What is claimed is:

1. An RFID tag system, comprising:
an RFID portal having an RFID interrogator associated therewith; and
a device having an RFID transponder and a communication interface whereby data can be communicated between the device and the portal via a communication channel established between the RFID transponder and the RFID interrogator.

2. A system according to claim 1 wherein the device is a camera.

3. A system according to claim 1 wherein the device is a keypad.

4. A system according to claim 1 wherein the device is a PDA.

5. A system according to claim 1 wherein the device is a communicator.

6. A system according to claim 1 wherein the device is a phone.

7. A system according to claim 1 wherein the portal has a peripheral unit attached thereto and wherein the device is able to access the peripheral via a communication link established between the RFID transponder and the RFID interrogator.

8. A system according to claim 7 wherein the peripheral unit is a mass storage device.

9. A system according to claim 7 wherein the peripheral unit is a display.

10. A system according to claim 7 wherein the peripheral unit is a speaker transducer.

11. A system according to claim 7 wherein the peripheral unit is a communication port.

12. A method for operating an RFID system including an interrogator, comprising:
fitting a device with an RFID transponder to form a transponder fitted device;
communicating information between the device to the interrogator via an RFID communication channel established between the transponder and the interrogator.

13. A method according to claim 12 wherein the communicating comprises:
modulating information onto a backscatter signal transmitted from the transponder.

14. A method according to claim 12 wherein the communicating comprises:
demodulating a signal transmitted from the interrogator and received at the transponder.

15. A method according to claim 12 further comprising:
operating the interrogator to regularly transmit an interrogation signal; and
periodically check for the presence of a device having a transponder.

16. A method according to claim 12 wherein the communicating comprises sending data from the transponder fitted device to the interrogator.

17. A method according to claim 12 wherein the communicating comprises sending data from the interrogator to the transponder fitted device.

18. An RFID portal arrangement, comprising:
an interrogator constructed and arranged to transmit an interrogation signal and receive a backscatter signal from an RFID transponder; and
control logic constructed and arranged so as to be operative to:
determine the presence of an RFID transponder fitted device,
establish communication between the interrogator and the RFID transponder fitted device.

19. An RFID portal arrangement according to claim 18 further comprising:
a communication port constructed and arranged to permit the interrogator to communicate with an object other than the transponder fitted device.
